(19) United States
(12) Patent Application Publication
(10) Pub. No.: US 2026/0178288 A1
(43) Pub. Date: Jun. 25, 2026

(54) Method and Device for Checking Algorithm Integrity for Generated Program Code for Computing a Neural Network in a Hardware Environment

(71) Applicant: Robert Bosch GmbH, Stuttgart (DE)

(72) Inventors: Sebastian Boblest, Duernau (DE); Benjamin Wagner, Friedrichshafen (DE); Duy Khoi Vo, Waiblingen (DE); Leif Sulaiman, Lund (SE); Markus Lochmann, Reutlingen (DE); Ulrik Hjort, Malmö (SE)

(21) Appl. No.: 19/422,890

(22) Filed: Dec. 17, 2025

(30) Foreign Application Priority Data
Dec. 20, 2024 (DE) 10 2024 212 259.9

(51) Int. Cl. G06F 8/35; G06N 3/10

(52) U.S. Cl. CPC G06F 8/35; G06N 3/10

(57) ABSTRACT

A computer-implemented method is for operating a code generator to create and implement a tested program code for computing a neural network in a hardware environment. The method includes creating a program code for computing a neural network in a hardware environment based on a defined neural network, and providing a verification code to the created program code. The verification code, when executed, checks execution of the program code in the hardware environment using at least one verification criterion. The method further includes implementing and executing the program code provided with the verification code in the hardware environment. According to the method, if it is determined that the at least one verification criterion is satisfied, creating the program code without a verification code, and implementing the program code provided without the verification code in the hardware environment.

This application claims priority under 35 U.S.C. § 119 to patent application no. DE 10 2024 212 259.9, filed on Dec. 20, 2024 in Germany, the disclosure of which is incorporated herein by reference in its entirety.

The disclosure relates to the implementation of a program code in a hardware environment, such as that occurring as microcontroller-controlled control devices and the like. The disclosure further relates to methods for checking generated program code for computing neural networks.

### BACKGROUND

Neural networks have become a prevalent class of algorithms in both science and industry over the past ten years. A key point in their deployment in production is to ensure that these algorithms work properly when installed on the hardware environment for which they were generated. This is mandatory for use in safety-critical applications such as automotive, medical equipment, or aerospace applications.

The manner in which neural networks are developed is by nature very exploratory, and therefore many neural network architectures need to be installed on the target hardware during product development. This continues throughout the product life cycle in the form of software updates. It is therefore not possible to manually check all neural networks employed, regardless of whether they are implemented in the form of generated high-level code such as C, low-level code such as LLVM or even assembler, or in the form of calls to a pre-implemented library. It is therefore necessary to perform automated checks of the program code.

The required checks that ensure that an implementation of a neural network fulfils the desired function for which it was designed for the hardware environment relate to data integrity and algorithm integrity. While data integrity must typically be tested independently of implementation on the hardware environment, algorithm integrity includes measures that ensure that the program code of the implemented neural network represents the originally trained network substantially correctly. That is, for all input data, the output of the neural network created is substantially equal to the output of the originally trained neural network. This also includes checks to ensure that the code of the neural network used does not contain errors that could lead to errors in the hardware environment. These errors could be caused by dividing by zero, other illegal mathematical operations, or illegal memory accesses, such as accessing arrays outside of the scope.

It is the object of the disclosure to provide a code generator for creating a program code for computing a neural network in a hardware environment that automatically checks a program code for the hardware environment in question.

### SUMMARY

This task is solved by the method for operating a code generator to create and implement a tested program code for computing a neural network in a hardware environment as disclosed herein.

According to a first aspect, a computer-implemented method for operating a code generator to create and implement a tested program code for computing a neural network in a hardware environment is provided, comprising the following steps: (i) creating a program code for computing a neural network in a hardware environment based on a defined neural network; (ii) providing a verification code to the created program code, wherein the verification code, when executed, verifies execution of the program code in the hardware environment using at least one verification criterion; (iii) implementing and executing the program code provided with the verification code in the hardware environment; (iv) if it is determined that the at least one verification criterion is satisfied, creating the program code without a verification code; (v) implementing the program code provided without a verification code in the hardware environment.

As part of code generation, a program code for computing a neural network is created using a code generator such as Embedded AI Coder. Here, a neural network is created as a program code that can be executed on a microprocessor, microcontroller, GPU, or dedicated neural network accelerator as a hardware environment. The hardware environment may correspond to the unit in which the program code is ultimately executed, or to an equivalent environment, such as x86.

The program code is based on a defined neural network provided in a common definition description, such as an onnx file, a model stored in keras, a tensorflow-lite model, or an exported pytorch file. It may be formed in a higher programming language, such as in C, in a lower-level representation such as LLVM or inline assembly, or as a combination of such representations, such as C code, invoking pre-implemented library functions.

Prior to implementing the created program code in a hardware environment, especially when used in safety-critical applications, it is important to test its algorithm integrity. To this end, the above method provides for the automated check of the created program code based on one or more verification criteria. Only if all verification criteria to be tested are met will the created program code constitute a proper program code and will be implemented in the hardware environment.

Thus, the core of the above method for operating the code generator is to automatically check a program code for an implemented neural network for algorithm integrity. An implemented program code can then be tested as proper or error-free for the corresponding hardware environment, so that it can be indicated whether the implemented program code satisfies all the algorithm integrity requirements for the intended hardware environment. If an error is detected, it may be provided that the program code is not used in the hardware environment.

To check a verification criterion, the program code created with the corresponding verification code is executed on the hardware environment.

It may be provided that the at least one verification criterion comprises at least one of the following checks: (i) that an execution of the created program code in the hardware environment writes an output of a layer to a memory area only within a memory area intended for the operation of the created program code; (ii) that the numerical output of a calculation of the individual layers of the neural network by the created program code corresponds to the numerical output of the calculation of the corresponding layers of the original neural network; (iii) that the calculation of each layer of the created program code writes a corresponding output only to a memory area assigned thereto.

The verification criterion with which the global memory integrity is to be checked is to ensure that the created program code does not write to a memory area outside of the memory assigned to it. For example, the memory for calculating the neural network may be placed in a larger auxiliary memory area. The entire auxiliary memory area is initialized with fixed values and then the program code is executed. After execution of the created program code, only the values in the memory area corresponding to the memory within the auxiliary memory area may have changed. Otherwise, the verification criterion is not satisfied.

The verification criterion with which the local algorithm integrity is checked ensures that the results of the calculations of the individual layers of the created program code correspond to the calculation of the layers of the original neural network. This check verifies that each layer in the created program code generates a correct numerical output. When this verification criterion is met, the individual layers are implemented numerically correctly and the outputs of the individual layers are correct. The calculation of the individual layers of the created program code results in output tensors that are buffered for comparison with the results of the calculation of the layers of the original.

The numerical output of the original network is determined using the underlying tool, e.g., with the onnx runtime for an onnx file, the tensorflow lite interpreter for tensorflow models, Pytorch, or with a defined standard library that provides implementations of the layers of the neural network, such as CMSIS-NN, combined with a tool that uses the implementations of the standard library to map the original neural network. One such tool is, for example, tensorflow lite micro.

To prevent the output tensors of the intermediate results from being overwritten by further calculations, the comparison can be performed immediately after executing the corresponding layer of the created program code. This may be performed in the hardware environment or in the hardware of the code generator.

Alternatively, the output tensors of the intermediate results of the execution of the generated program code can be copied to a separate memory area after its execution and analyzed using the hardware of the code generator after completion of the execution of the generated program code.

Alternatively, a memory layout may be used to execute the created program code that does not overwrite intermediate results of the individual layers. Local algorithm integrity testing with a simplified storage layout should always be supplemented by a check with the production memory layout in order to also test for possible errors related to the memory layout created prior to code generation, as the memory planning algorithm may be erroneous. Immediately after performing each calculation of a layer, the respective output is copied into a separate memory area. The comparison may then be made for the simplified memory layout.

The high memory requirement renders this strategy impracticable for in-device testing on devices with highly restricted memory, especially because the memory requirement grows with each new layer in the program code created. An emulated provision with the same memory layout accepts little remaining uncertainty because the test is not performed in the hardware environment.

Alternatively, the checking for algorithm integrity may be performed incrementally only for one or more particular layers. In this case, for all layers of the neural network, verification code for the check is inserted incrementally into the original program code for only one layer of the neural network at a time. Each version checks the algorithm integrity for the corresponding layer.

When using tiling, the algorithm integrity check may require caching output tensors from sub-calculations that would otherwise be overwritten by subsequent calculations and would then no longer be available for an algorithm integrity check.

It may therefore be provided that the defined neural network comprises a serial sequence of multiple layers to be calculated in the program code created using tiling in sub-calculations. In this case, the layers subjected to tiling are calculated strand by strand so that a partial output tensor is provided for each strand. The partial output tensors are combined to form an output tensor of the last layer subjected to tiling. Here, the algorithm integrity is checked by combining the numerical outputs of each of the output tensors of a specific tiled layer of each strand and comparing the combined output tensors with the numerical output of the original neural network.

Tiling is a strategy for reducing the maximum amount of memory required by partitioning some successive layers in the network. Layers computed with tiling may include additional slice operators that do not have an equivalent in the defined neural network according to the network definition. These divide the input tensors of the strands subjected to tiling into partial input tensors for the respective strands subjected to tiling. Also, by tiling, additional concatenation operators are introduced that have no correspondence in the defined neural network. With tiling, multiple partitioned layers are computed strand by strand until there is one output tensor as a partial result, which is then combined into the overall output tensor by means of additional concatenation after all strands have been calculated. The partial results of the layers within a tiled strand are never fully present in memory, and in any case, even when using a memory layout where no results are overwritten, are not contiguous in memory.

Therefore, for layers subjected to tiling, the above criterion must be checked to ensure that the output tensors of the partial calculation of a layer are temporarily stored by the program code in such a way that they can be combined externally to the hardware environment or internally to the output tensor of the layer (in particular by concatenation) or are already stored contiguously, and that the combined output tensors correspond to the calculation of the layers of the original neural network.

It may be contemplated that even prior to code generation, a check may be conducted to determine whether the neural network has no characteristics with which the implementation could fail or will certainly fail. This is the case, for example, if (i) the neural network contains a layer that is not supported; (ii) the neural network includes a layer having a configuration that is not supported, such as an unsupported kernel size in a convolution; (iii) the neural network uses a data type that is not supported; (iv) the generated program code does not fit within the data store of the hardware environment.

Connected layers can occur consisting of two consecutive operations and whose intermediate results are never written to a memory area. For example, ReLU, Leaky-ReLU, and other activation functions are combined with the previous layer. Also, pooling layers can be merged with a previous convolutional layer.

To circumvent this limitation, the layer fusion may be optionally implemented in the code generator. First, the created program code is generated without layer fusion, then, if all of the above criteria are met, the created program code is regenerated with layer fusion and all criteria are reviewed repeatedly.

Furthermore, a verification criterion may be provided that indicates that a calculation of each layer of a created program code will only write to a memory area assigned to it. Each layer of the created program code may only write to a weight prefetch buffer to pre-load the calculation parameters prior to the actual calculation, and may perform the calculation only with access to a scratchpad buffer and an intermediate buffer for outputting the output tensor. To check whether the layer does not write to other memory areas, the data in the global memory before weight prefetching is compared with the data after weight prefetching, and the data before executing the layer is compared with the memory after executing the layer.

This test is important to detect possible failures in the layer implementations and can be performed in two ways: (i) copying the full memory of the neural network to a separate auxiliary memory area after computing each layer in the created program code and comparing all versions after the created program code has been fully executed. In so doing, the described memory area may be identified and compared with the memory layout for the created program code in order to detect any writing to memory outside the memory area specified by the memory layout for each layer, and (ii) copying the memory only before weight prefetching each layer and comparing with the state after weight prefetching, then copying after weight prefetching. This means that prior to computing each layer and comparing it with the state after computing the layer, the faulty memory area described above can be identified by comparing it with the memory layout.

In order not to miss potential problems with weight prefetching, the weight prefetching buffer should be checked after performing weight prefetching but before calling the calculation of the actual layer.

The high memory requirement renders this strategy unfeasible without modification for in-device testing on devices with highly restricted memory, since even the procedure corresponding to Point 2 doubles the required memory.

In these cases, a step-wise procedure is necessary. For example, in each step, 10% of the memory may be cached and the operation repeated 10 times. Due to the fully static memory layout of the implementation, this procedure is equivalent to a one-time check of all of the memory.

### BRIEF DESCRIPTION OF THE DRAWINGS

Preferred embodiments are described in more detail below with reference to the accompanying drawings. It shows:

FIG. 1 a schematic illustration of a platform for code generation and implementation in a hardware environment;

FIG. 2 schematically shows a flowchart illustrating a method for checking an algorithm integrity for a generated program code for computing a neural network in a hardware environment; and

FIGS. 3A, 3B, and 3C show a section of a defined and created neural network with layers that are tiled, and a memory plan for storing output tensors of the individual layers.

### DETAILED DESCRIPTION

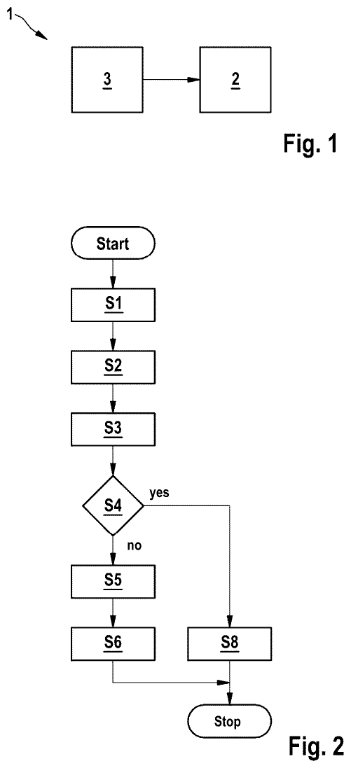

FIG. 1 shows a block diagram of a platform 1 with a code generator for performing code generation for creating a program code and implementing a generated or created program code in a hardware environment 2. For example, the hardware environment corresponds to a control device having a microcontroller, microprocessor, or the like. Code generation is done on a conventional computer 3 or workstation based on the specified configuration of a neural network. Computer 3 is configured to perform memory planning and code generation, wherein memory planning initially performs a placement of memory areas for the individual calculation steps of the neural network for including at least one input data block, a scratchpad block, optionally a weight prefetching block, and at least one output data block.

A scratchpad block is a memory area that an implementation of a neural network layer requires to store intermediate results during the calculation. It does not contain the actual results of the neural network layer and its content is not used by the subsequent layers.

An output data block contains the output of a layer in the network if it is not an output of the entire network. Output data blocks are used as input by later layers of the neural network.

A weight prefetching block contains trained weights of a neural network that are pre-loaded from a data store into memory to reduce processing time.

The memory is used to store all of the input and output data blocks, scratchpad blocks, and weight prefetching blocks for as long as needed to calculate one or more layers. During later layer execution, the same memory areas may be reused to store different data.

The code generator is used to create the program code adapted to a hardware environment. Once the code has been generated, it is conventionally transferred to the hardware environment 2, where it is implemented or executed.

However, it must be ensured that the program code is reliably executed on the hardware environment; an automated method is provided for this purpose, which is performed by the code generator.

The method described below serves to check the algorithm integrity for the generated program code for the calculation of the neural network before implementing the program code in the hardware environment 2.

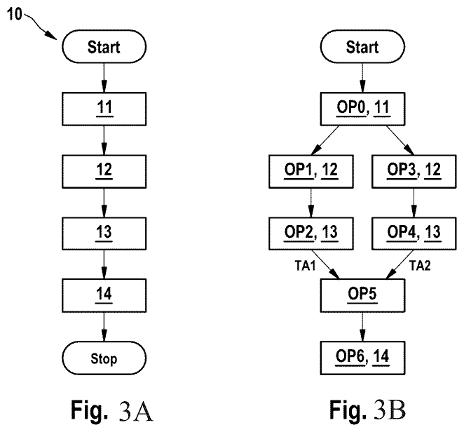

The procedure of the method is described in more detail using the flow chart of FIG. 2.

For this purpose, in step S1, the program code created for calculating a neural network in a hardware environment is provided based on a defined neural network. The defined neural network may, for example, be provided as an onnx file, a keras model, a tensorflow-lite model, or a pytorch model. It can be implemented in a high-level language such as C, a lower representation such as LLVM or inline assembler, or a combination of such representations, e.g. as a C code invoking pre-implemented library functions.

Subsequently or simultaneously with step S1, in step S2, the created program code is provided with a verification code, wherein the verification code, when executed, verifies the execution of the program code in the hardware environment based on at least one verification criterion.

Then, in step S3, the program code provided with the verification code is implemented and executed in the hardware environment.

In step S4, it is checked whether the at least one verification criterion is satisfied. If this is the case (alternative: yes), the method can be continued with step S5, otherwise (alternative: no) an error is signaled in step S8 and the method ends.

If multiple verification criteria are reviewed, the program code may always be provided with a new verification code required for the verification criterion and implemented in the hardware environment to perform the verification.

In step S5, the program code is generated or created without a verification code.

In step S6, the program code created without a verification code is implemented in the hardware environment.

The check can be done using various verification criteria.

Thus, a calculation of the program code created may be performed that is assigned memory areas of an auxiliary memory. If the calculation describes a memory area outside of a memory intended for the operation of the created program code, an error may be detected in the algorithm.

Further, the created program code may be checked for algorithm integrity by calculating the numerical output of individual layers of the defined neural network and comparing it with the numerical output of corresponding layers of the created neural network. If deviations exceed the magnitude of the expected deviations, for example due to the finite precision of floating point numbers, an error can be determined in the algorithm.

When using tiling, the algorithm integrity check may require caching output tensors from partial calculations that would otherwise be overwritten by subsequent calculations of layers subjected to tiling and would then no longer be available for an algorithm integrity check.

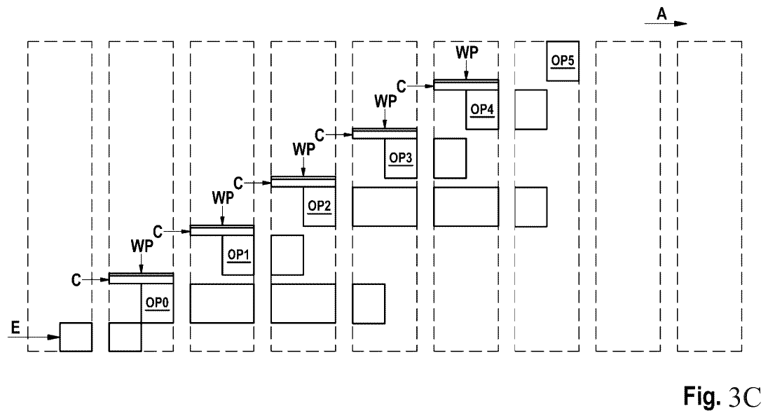

FIG. 3A shows an example of a section from a defined neural network 10 with 3 serial convolutional layers 11-13 and a subsequent fully connected layer 14. FIG. 3B shows the structure of the neural network according to the program code created, with two of the convolutional layers being subjected to tiling.

The layers subjected to tiling 12, 13 are sequentially calculated in OP1, OP2, OP3, OP4 so that a partial output tensor TA1, TA2 is provided for each strand that is combined into an output tensor A of the last tiled layer. The algorithm integrity is checked by combining the numerical outputs of the partial output tensors of the last tiled layer of each strand and comparing the combined output tensors with the numerical output of the calculation of the corresponding layer of the created neural network according to a standard library.

In order to also check the calculation of layer 12 subjected to tiling, the respective partial output tensors of the operations OP1, OP3 are cached so that they are not overwritten by a subsequent operation. The cached partial output tensors are combined and compared with the numerical output of the output tensor of the relevant layer of the original neural network.

It can be seen in the memory plan of FIG. 3C, which illustrates the memory areas in which the output tensors of each operation OP0-OP6 are written, that the output tensors of operations OP1 and OP3 are present in memory separately after performing the operation OP3. In this way, the testing of the algorithm integrity may be performed after performing the operation OP3.

Further, the created program code may be checked by performing a calculation of each layer of the created program code. If it is determined that writing is taking place in a memory area that has not been assigned to that layer, an error can be detected in the algorithm.

It may be contemplated that even prior to code generation, a check may be conducted to determine whether the neural network has no characteristics with which the implementation could fail or will certainly fail. This is the case, for example, if (i) the neural network contains a layer that is not supported; (ii) the neural network includes a layer having a configuration that is not supported, such as an unsupported kernel size in a convolution; (iii) the neural network uses a data type that is not supported; (iv) the generated program code does not fit within the data store of the hardware environment.

What is claimed is:

1. A computer-implemented method for operating a code generator to create and implement a tested program code for computing a neural network in a hardware environment, the method comprising:
creating a program code for computing a neural network in a hardware environment based on a defined neural network;
providing a verification code to the program code, the verification code, when executed, checks execution of the program code in the hardware environment using at least one verification criterion;
implementing and executing the program code provided with the verification code in the hardware environment; and
when it is determined that the at least one verification criterion is satisfied (i) creating the program code without the verification code, and (ii) implementing the program code provided without the verification code in the hardware environment.

2. The method according to claim 1, wherein the at least one verification criterion comprises a check:
that an execution of the program code in the hardware environment writes an output of a layer to only a memory area intended for an operation of the program code;
that, to test algorithm integrity using an algorithm integrity test, a numerical output of a calculation of individual layers of the neural network computed by the program code corresponds to a numerical output of a calculation of an original neural network; and
that a calculation of each layer of the program code writes a corresponding output only to the memory area assigned thereto.

3. The method according to claim 2, wherein:
the program code is created from a defined program code using a code generator, and
the defined program code describes a neural network provided in a common definition description including an onnx file, a model stored in keras, a tensorflow-lite model, or an exported pytorch file.

4. The method according to claim 3, wherein:
to check the program code based on a calculation of the program code, an output of a layer is written to a memory area, and
it is checked whether the memory area is outside the memory area provided for a respective layer of the neural network.

5. The method according to claim 2, wherein:
for checking based on the numerical output of the individual layers of the defined neural network, a calculation of the individual layers of the program code is performed and, with aid of a tool for performing an original neural network or a standard library, the layers of the neural network are calculated according to a network definition in order to determine output tensors and store them temporarily, and
the individual layers of the program code are calculated in order to obtain corresponding output tensors, which are compared with the output tensors of the neural network performed using the tool for performing the neural network or using the standard library in order to determine that each layer in the program code generates a correct numerical output.

6. The method according to claim 5, wherein:
the defined neural network comprises a serial sequence of multiple layers, which are to be calculated in the program code using tiling in sub-calculations,
the layers subjected to tiling are calculated strand by strand, so that a partial output tensor is provided for each strand, which are combined to form an output tensor of a last layer subjected to tiling, and
the algorithm integrity test is performed by combining the numerical outputs of each of the output tensors of a specific tiled layer of each strand and comparing the combined output tensors with the numerical output of the calculation of the corresponding layer of the created neural network using a tool or according to a standard library.

7. The method according to claim 1, wherein a check is performed before the program code is created in order to create the program code only if:
the defined neural network contains a layer that is not supported;
the defined neural network includes a layer having a configuration that is not supported, particularly an unsupported kernel size in a convolution;
the defined neural network uses a data type that is not supported; and/or
the program code has a memory requirement that is greater than a data memory of the hardware environment.

8. The method according to claim 1, wherein a code generator is configured to carry out the method.

9. The method according to claim 1, wherein a computer program product comprises instructions which, when the computer program is executed by at least one data processing unit, cause the at least one data processing unit to carry out the method.

10. A non-transitory machine-readable storage medium comprising commands which, when executed by at least one data processing device, cause the at least one data processing device to perform the method according to claim 1.
